(19) United States
(12) Patent Application Publication
(10) Pub. No.: US 2018/0292228 A1
(43) Pub. Date: Oct. 11, 2018

(54) Device, system and method for navigation

(71) Applicant: GRANT YE, Pleasanton, CA (US)

(72) Inventor: Grant Ye, Pleasanton, CA (US)

(21) Appl. No.: 15/482,716

(22) Filed: Apr. 8, 2017

(51) Int. Cl. G01C 21/36

(52) U.S. Cl. CPC G01C 21/3629; G01C 21/3644

(57) ABSTRACT

The systems and methods disclose a waypoint generation mechanism: a portable sensing device, wherein the portable sensing device includes at least an sensor to detect location, and a wireless transmitter, a mobile device that is configured to receive and store information of the locational differences between the two sample positions during a trip, and a cloud-based server that is configured to generate a map containing information of the locational differences between the two sample positions and the navigation way points for the trip using information received.

### PRIORITY CLAIM

This application is a non-provisional utility patent application

### FIELD OF THE INVENTION

At least one embodiment of the present invention pertains to a method of generating navigation waypoints according to a trip by a user, establishing a starting point where the user starts the trip in a map contained by a portable sensing device, receiving information of the locational differences between two sample positions from the portable sensing device, generating navigation waypoints from the information the locational differences between two sample positions, recording detailed turn by turn instructions, upstairs or downstairs information, doors and slope information with the navigation waypoints and storing the navigation waypoints in a navigation file. At least one embodiment of the present invention further pertains to a portable tracking device to implement the method above. At least one embodiment of the present invention further pertains to a system to implement the method above

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In the modern society, electronic navigation devices employing Global Positioning System (“GPS”) receivers are well known. The GPS includes a plurality of satellites that are in orbit about the Earth. The orbit of each satellite is not necessarily synchronous with the orbits of other satellites and, in fact, is likely asynchronous. The GPS receiver device receives spread spectrum GPS satellite signals from the various satellites. The spread spectrum signals continuously transmitted from each satellite utilize a highly accurate frequency standard accomplished with an extremely accurate atomic clock. Each satellite, as part of its data signal transmission, transmits a data stream indicative of that particular satellite. The GPS receiver device acquires spread spectrum GPS satellite signals from at least three satellites to calculate its two-I dimensional position by triangulation. Acquisition of an additional signal, resulting in signals from a total of four satellites, permits the GPS receiver device to calculate its three-dimensional position.

Although GPS enabled devices are often used to describe navigation devices, it will be readily appreciated that sometimes that satellites are not accessible for a person, for example, having a difficulty finding his/her way in a cave or indoor complex. Therefore, a portable device and a related system that can plot and save navigational way points without help of GPS would be greatly helpful in such situations. In fact, in some situations, these technologies may become life-saving.

In addition, the portable device can be paired with a mobile phone or smart phone. The mobile phone can act as a processor for the information transmitted from the tracking device, thus enable the portable device to be small and can be attached to the body of a user in a trip. The mobile phone can generate a map and waypoints. In addition, a cloud server can receive relevant data from the mobile phone, thus processing the data and upload to pre-determined social accounts.

### SUMMARY

Techniques introduced here provide a method for generating navigation waypoints according to a trip by a user, comprises: establishing a starting point where the user starts the trip in a map contained by a portable sensing device, wherein the portable sensing device is configured to sense locational differences between the user's two sample positions, receiving information of the locational differences between two sample positions from the portable sensing device, generating navigation waypoints from the information the locational differences between two sample positions and storing the navigation waypoints in a navigation file and recording detailed turn by turn instructions, upstairs or downstairs information, doors and slope information with the navigation waypoints. In addition, the techniques may also include displaying the waypoints in a display, starting from the starting point in the map, following the navigation way points and integrating images, texts, videos or other multimedia related to the waypoints during the trip. In addition, one or more checkpoints can be placed by the user.

Techniques introduced here also provide a portable sensing device, comprising: an sensor, wherein the sensor is configured to sense locational differences between the user's position during a trip and the starting point where a user started the trip, wherein the locational differences are three-dimensional; a map, wherein the map is configured to record the locational differences from the sensor during the trip by the user and generate navigation waypoints and record detailed turn by turn instructions, upstairs or downstairs information, doors and slope information with the navigation waypoints; and a memory unit, wherein the memory unit stores the map and navigation waypoints. In addition, the portable sensing device may include a wireless transmitter, wherein the wireless transmitter is configured to transmit the map and the navigation way points to other mobile devices. In addition, the portable sensing device may include a display, wherein the display is configured to show between the two sample positions, the navigation way points overlay with the map. In addition, the portable sensing device may enable that images, texts and videos related to the waypoints during the trip are stored with the respective waypoints, wherein the respective waypoints can be selected by user manually, wherein one or more checkpoints can be placed by the user, wherein the one or more checkpoints are configured to correct the map.

Techniques introduced here also provide A system for generating and utilizing navigation waypoints, comprising: a portable sensing device, wherein the portable sensing device includes at least an sensor, and a wireless transmitter, wherein the sensor is configured to sense locational differences during a trip between two sample positions where a user started the trip, wherein the locational differences are three-dimensional, wherein the wireless transmitter is configured to transmit the locational differences relative to between the two sample positions to other devices; a mobile device, wherein the mobile device is configured to receive information of the locational differences between the two sample positions, wherein the mobile device is configured to have applications to process the information of the locational differences between the two sample positions and generate a map containing between the two sample positions and the navigation way points for the trip and record detailed turn by turn instructions, upstairs or downstairs information, doors and slope information with the navigation waypoints. In addition, the mobile device may has a display to visualize the map and the navigation way points. In addition, the mobile device may has a mobile application to share the map and the navigation way points with other mobile devices. In addition, images, texts and videos related to the waypoints during the trip are stored with the respective waypoints, wherein one or more checkpoints can be placed by the user, wherein the one or more checkpoints are configured to correct the map. The portable sensing device is configured to tell the user all the destination options that are available to the user. The user can use voice to tell the portable sensing device the destination information. The portable sensing device can use audio to dictate to the user the directions for the navigation.

Techniques include here also provide a system for generating and utilizing navigation waypoints, comprising: a portable sensing device, wherein the portable sensing device includes at least an sensor, and a wireless transmitter, wherein the sensor is configured to sense locational differences during a trip between two sample positions, wherein detailed turn by turn instructions, upstairs or downstairs information, doors and slope information are recorded with the locational differences, wherein the locational differences are three-dimensional, wherein the wireless transmitter is configured to transmit the locational differences relative to between the two sample positions to other devices; a mobile device, wherein the mobile device is configured to receive and store information of between the two sample positions and the locational differences during a trip relative to between the two sample positions, wherein the mobile device is configured to two modes, wherein in the first mode, the mobile device is configured to pre-process and upload the information of the locational differences between the two sample positions to any cloud-based server, wherein in the second mode, the mobile device is configured to process the information and generate a map containing between the two sample positions and the navigation way points for the trip ; and a cloud-based server, wherein the cloud-based server is configured to receive the information of the locational differences between the two sample positions from the mobile device via a wireless network, wherein the cloud-based server is configured to process the information and generate a map containing between the two sample positions and the navigation way points for the trip, wherein the cloud-based server is configured to share the map within a pre-determined group of mobile devices. In addition, the wireless network is a secured wireless network. In addition, images, texts and videos related to the waypoints during the trip are stored with the respective waypoints. In addition, the portable sensing device is attached to footwear of the user. In addition, the cloud-based server is configured to upload the information of the waypoints and the images, the texts and the videos related the waypoints to social media accounts of the user, wherein one or more checkpoints can be placed by the user, wherein the one or more checkpoints are configured to correct the map. In addition, the system is configured to match a second user's movement tracking pattern to a segment of the map to identify position of the second user's position at the map.

Other aspects of the technology introduced here will be apparent from the accompanying figures and from the detailed description which follows.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a diagram of a method for generating navigation waypoints according to a trip by a user

FIG. 2 illustrates a diagram of a second method for generating navigation waypoints according to a trip by a user

FIG. 3 illustrates a diagram of a third method for generating navigation waypoints according to a trip by a user

FIG. 4 illustrates a diagram of a fourth method for generating navigation waypoints according to a trip by a user

FIG. 5 illustrates a diagram of a portable sensing device

FIG. 6 illustrates a diagram of another portable sensing device

FIG. 7 illustrates a diagram of a route by a user with multiple waypoints

FIG. 8 illustrates a diagram of a system of navigational usage that includes at least a portable sensing device and a mobile device

FIG. 9 illustrates a diagram of a system of navigational usage that includes at least a portable sensing device, a mobile device and a cloud server.

FIG. 10 illustrates an example of using check point and existing route to identify position of a user in the current route

FIG. 11 illustrates a diagram of a route and waypoints in itv

FIG. 12 illustrates a diagram of a system of navigational usage that includes at least a portable sensing device and a mobile device

FIG. 13 illustrates a diagram of a system of navigational usage that includes at least a portable sensing device, a mobile device and a cloud server.

### DETAILED DESCRIPTION

References in this specification to “an embodiment,” “one embodiment,” or the like, mean that the particular feature, structure, or characteristic being described is included in at least one embodiment of the present invention. Occurrences of such phrases in this specification do not all necessarily refer to the same embodiment, however.

In the modern world, portable navigational device or system is very helpful and in some situations, life-saving.

In the modern society, electronic navigation devices employing Global Positioning System (“GPS”) receivers are well known. The GPS includes a plurality of satellites that are in orbit about the Earth. The orbit of each satellite is not necessarily synchronous with the orbits of other satellites and, in fact, is likely asynchronous. The GPS receiver device receives spread spectrum GPS satellite signals from the various satellites. The spread spectrum signals continuously transmitted from each satellite utilize a highly accurate frequency standard accomplished with an extremely accurate atomic clock. Each satellite, as part of its data signal transmission, transmits a data stream indicative of that particular satellite. The GPS receiver device acquires spread spectrum GPS satellite signals from at least three satellites to calculate its two-I dimensional position by triangulation. Acquisition of an additional signal, resulting in signals from a total of four satellites, permits the GPS receiver device to calculate its three-dimensional position.

Although GPS enabled devices are often used to describe navigation devices, it will be readily appreciated that sometimes that satellites are not accessible for a person, for example, having a difficulty finding his/her way in a cave or indoor complex. Therefore, a portable device and a related system that can plot and save navigational way points without help of GPS would be greatly helpful in such situations. In fact, in some situations, these technologies may become life-saving.

The inventions described below are a comprehensive approach to solve navigation issues when there is no GPS available and no outside network can be utilized.

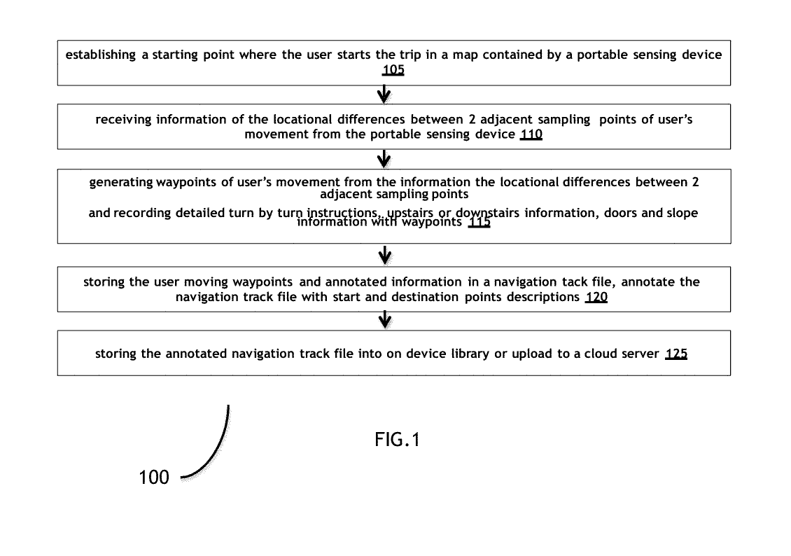

FIG. 1 illustrates a diagram of a method for generating navigation waypoints according to a trip by a user. In some embodiment, the method comprises a step 105 of establishing a starting point where the user starts the trip in a map contained by a portable sensing device. In some embodiment, the method comprises a step 110 of receiving information of the locational differences between 2 adjacent sampling points of user's movement from the portable sensing device.

In some embodiment, the method comprises a step 115 of generating waypoints of user's movement from the information the locational differences between 2 adjacent sampling points, and recording detailed turn by turn instructions, upstairs or downstairs information, doors and slope information with waypoints.

In some embodiment, the method comprises a step 120 of storing the user moving waypoints and annotated information in a navigation tack file, annotate the navigation track file with start and destination points descriptions.

In some embodiment, the method comprises a step 125 of storing the annotated navigation track file into on device library or upload to a cloud server.

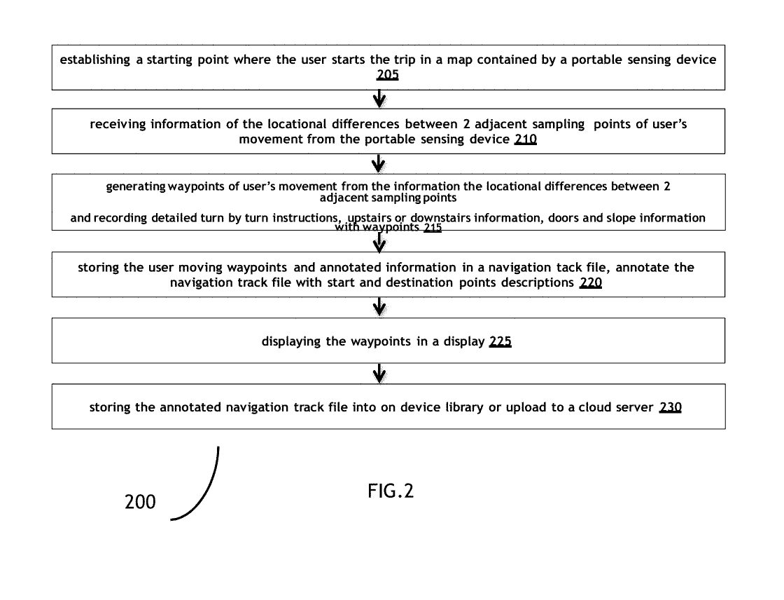

FIG. 2 illustrates a diagram of a second method for generating navigation waypoints according to a trip by a user. In some embodiments, the method comprises a step 205 of establishing a starting point where the user starts the trip in a map contained by a portable sensing device.

In some embodiments, the method comprises a step 210 of receiving information of the locational differences between 2 adjacent sampling points of user's movement from the portable sensing device.

In some embodiments, the method comprises a step 215 of generating waypoints of user's movement from the information the locational differences between 2 adjacent sampling points and recording detailed turn by turn instructions, upstairs or downstairs information, doors and slope information with waypoints.

In some embodiments, the method comprises a step 220 of storing the user moving waypoints and annotated information in a navigation track file, annotate the navigation track file with start and destination points descriptions.

In some embodiments, the method comprises a step 225 of displaying the waypoints in a display.

In some embodiments, the method comprises a step 230 of storing the annotated navigation track file into on device library or upload to a cloud server.

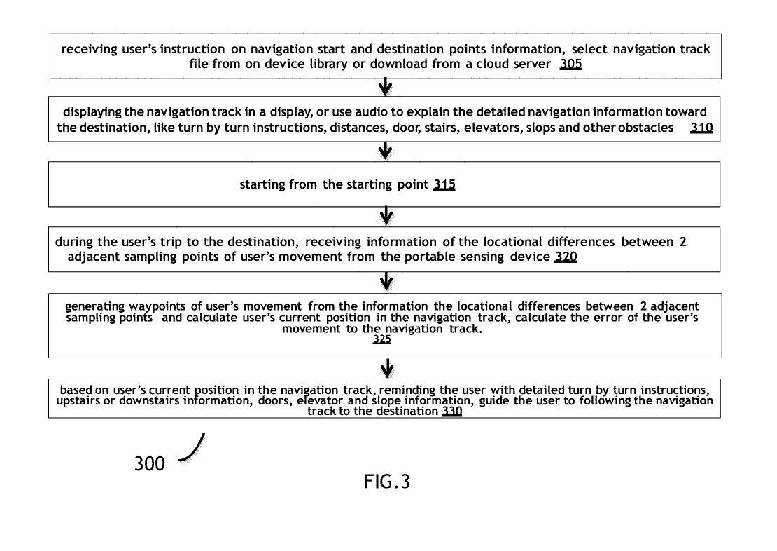

FIG. 3 illustrates a diagram of a third method for generating navigation waypoints according to a trip by a user. In some embodiments, the method comprises a step 305 of receiving user's instruction on navigation start and destination points information, select navigation track file from on device library or download from a cloud server.

In some embodiments, the method comprises a step 310 of displaying the navigation track in a display, or use audio to explain the detailed navigation information toward the destination, like turn by turn instructions, distances, door, stairs, elevators, slops and other obstacles.

In some embodiments, the method comprises a step 315 of starting from the starting point.

In some embodiments, the method comprises a step 320 of during the user's trip to the destination, receiving information of the locational differences between 2 adjacent sampling points of user's movement from the portable sensing device.

In some embodiments, the method comprises a step 325 of generating waypoints of user's movement from the information the locational differences between 2 adjacent sampling points and calculate user's current position in the navigation track, calculate the error of the user's movement to the navigation track file.

In some embodiments, the method comprises a step 330 of based on user's current position in the navigation track, reminding the user with detailed turn by turn instructions, upstairs or downstairs information, doors, elevator and slope information, guide the user to following the navigation track to the destination.

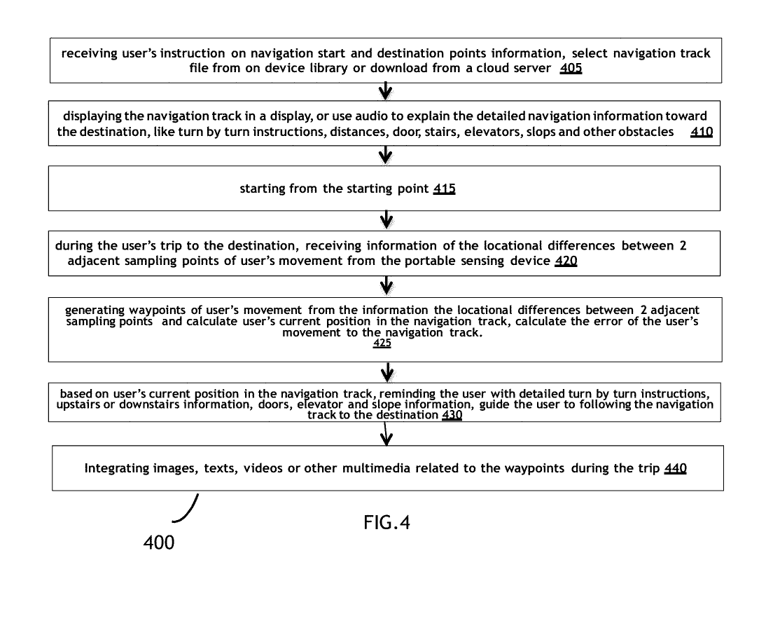

FIG. 4 illustrates a diagram of a third method for generating navigation waypoints according to a trip by a user. In some embodiments, the method comprises a step 405 of receiving user's instruction on navigation start and destination points information, select navigation track file from on device library or download from a cloud server.

In some embodiments, the method comprises a step 410 of displaying the navigation track in a display, or use audio to explain the detailed navigation information toward the destination, like turn by turn instructions, distances, door, stairs, elevators, slops and other obstacles.

In some embodiments, the method comprises a step 415 of starting from the starting point.

In some embodiments, the method comprises a step 420 of during the user's trip to the destination, receiving information of the locational differences between 2 adjacent sampling points of user's movement from the portable sensing device.

In some embodiments, the method comprises a step 425 of generating waypoints of user's movement from the information the locational differences between 2 adjacent sampling points and calculate user's current position in the navigation track, calculate the error of the user's movement to the navigation track file.

In some embodiments, the method comprises a step 430 of based on user's current position in the navigation track, reminding the user with detailed turn by turn instructions, upstairs or downstairs information, doors, elevator and slope information, guide the user to following the navigation track to the destination.

In some embodiments, the method comprises a step 440 of Integrating images, texts, videos or other multimedia related to the waypoints during the trip.

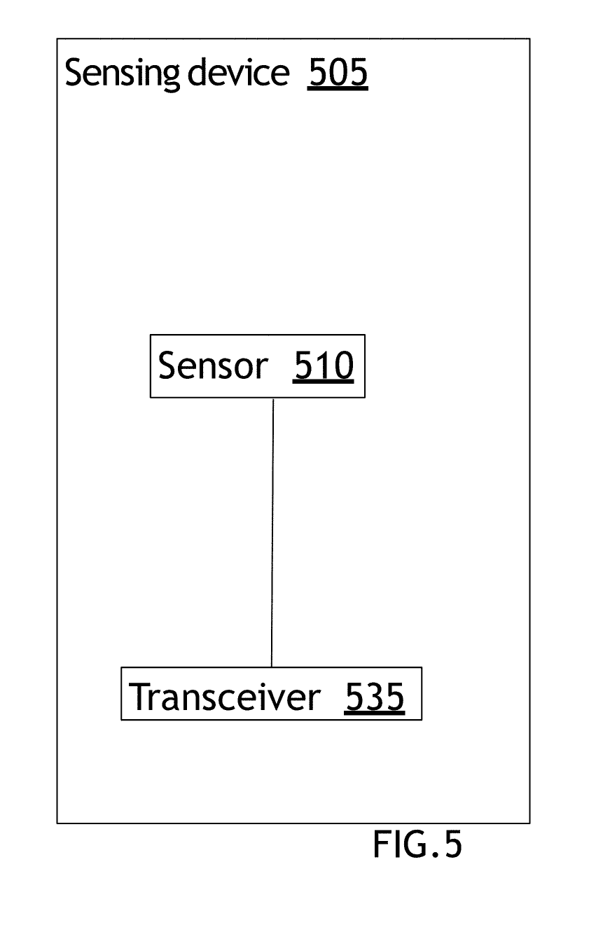

FIG. 5 illustrates a diagram of a mobile device 505 that are comprised by a mobile device 505. And this device is comprises of a sensor 510 and a transceiver 535. The sensor is comprises of memory unit 515, map 520 and navigation waypoints 525 and checkpoints 530. In some embodiment, portable sensing device 505 comprises a sensor 510, wherein the sensor 510 is configured to sense locational differences between the user's two sample positions, wherein the locational differences are three-dimensional. The mobile device also includes a transceiver 535. The sensor 510 generates measure data and sends the data through transceiver to the portable sensing device 505. The sensor 510 will not generate waypoint/map/notation. The portable sensing device 505 received the raw data from the sensor 510, then calculates the waypoint, generate map and allow the user to add notations to the map.

In some embodiment, the mobile device 505 also comprises a memory unit 515, wherein the memory unit stores a map 520 and navigation waypoints 525 and checkpoints 530. In some embodiment, the sensor 510 may pass information to memory unit 515. In some embodiments, map is generated by an algorithm stored in the memory unit 515. In some embodiments, navigation waypoints 525 are generated by recording the geo-position of the user by a pre-determined time interval. In some embodiments, the checkpoints 530 are generated by user manually click some button on the portable sensing device or by a pre-determined algorithm automatically. In some embodiment, images, texts and videos related to the waypoints 525 during the trip are stored with the respective waypoints, and the respective waypoints can be selected by user manually. In some embodiment, one or more checkpoints 530 can be placed by the user, wherein the one or more checkpoints 530 are configured to correct the map.

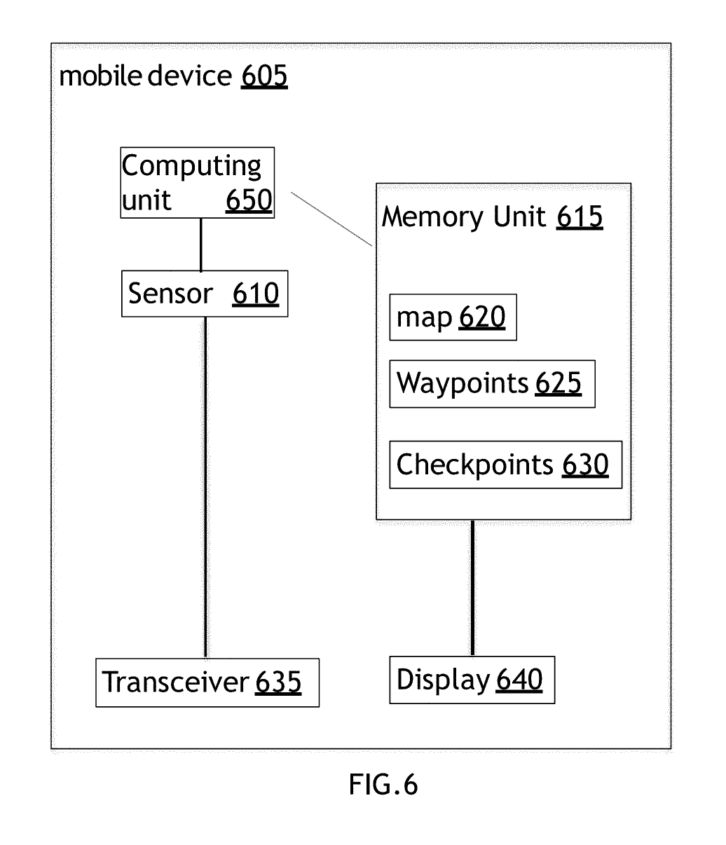

FIG. 6 illustrates a diagram of a mobile device 605 that are comprised by a sensor 610 that is comprise of a transmitter 635, a display 640 and a memory unit 615 that is comprised by a map 620 and navigation waypoints 625 and checkpoints 630. The sensor 610 is configured to sense locational differences between the user's two sample positions, wherein the locational differences are three-dimensional. The mobile device 605 also comprise of a computing unit 650 and a transceiver 635.

In some embodiment, the mobile device 605 also comprises a memory unit 615, wherein the memory unit stores a map 620 and navigation waypoints 625 and checkpoints 630. In some embodiment, the sensor 610 may pass information to memory unit 615. In some embodiments, map is generated by an algorithm stored in the memory unit 615. In some embodiments, navigation waypoints 625 are generated by recording the geo-position of the user by a pre-determined time interval. In some embodiments, the checkpoints 630 are generated by user manually click some button on the portable sensing device or by a pre-determined algorithm automatically. In some embodiment, images, texts and videos related to the waypoints 625 during the trip are stored with the respective waypoints, and the respective waypoints can be selected by user manually. In some embodiment, one or more checkpoints 630 can be placed by the user, wherein the one or more checkpoints 630 are configured to correct the map.

In some embodiment, transmitter 635 transmits information passing from sensor 610. In some embodiment, transmitter 635 can transmit information via RF, blue tooth or other wireless protocols.

In some embodiment, display 640 displays map 620, waypoints 625 and checkpoints 630. In some embodiments, users can zoom-in and zoom-out the map 620 and interact with map 620, waypoints 625 and checkpoints 630. In some embodiments, users can leave information and store information in the map 620, waypoints 625 and checkpoints 630. In some embodiment, one or more checkpoints can be placed by the user. In some embodiment, the one or more checkpoints can be used by the user to correct the navigation errors. In some embodiment, the multi-media information can be linked to the waypoints.

In some embodiment, the sensor in the mobile device measures the movement, the computation unit in the mobile device calculates to the waypoint, generate map and user of the mobile device add notations to the map.

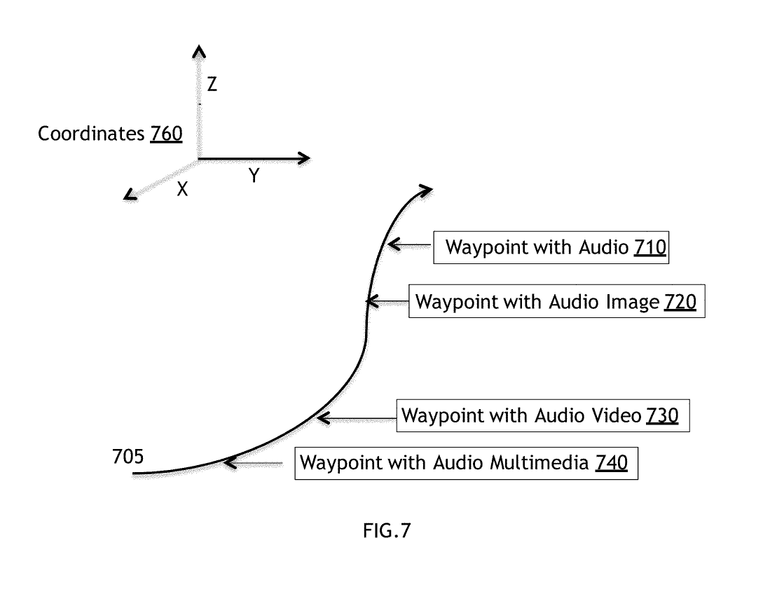

FIG. 7 illustrates a diagram of a route by a user with multiple waypoints. The route 705 traveled by a user can comprises multiple waypoints. Navigation waypoints are generated by recording the geo-position of the user by a pre-determined time interval or manually generated by a user. Multi-Media information, audio, video, and image information can be generated or left by the user. For example, In FIG. 7, the route 705 comprises of a waypoint with audio 710, a waypoint with image 720, a waypoint with video 730, a waypoint with multi-media 740. For example, audio information can be user's voice instruction to pass a waypoint. For example, image information can be a picture of the landmark near a waypoint. For example, video information can be a video recording of an event near a waypoint. For example, multimedia information can be a video clip with audio from the user when he or she passes through a waypoint. Coordinate 760 provides a reference for directions.

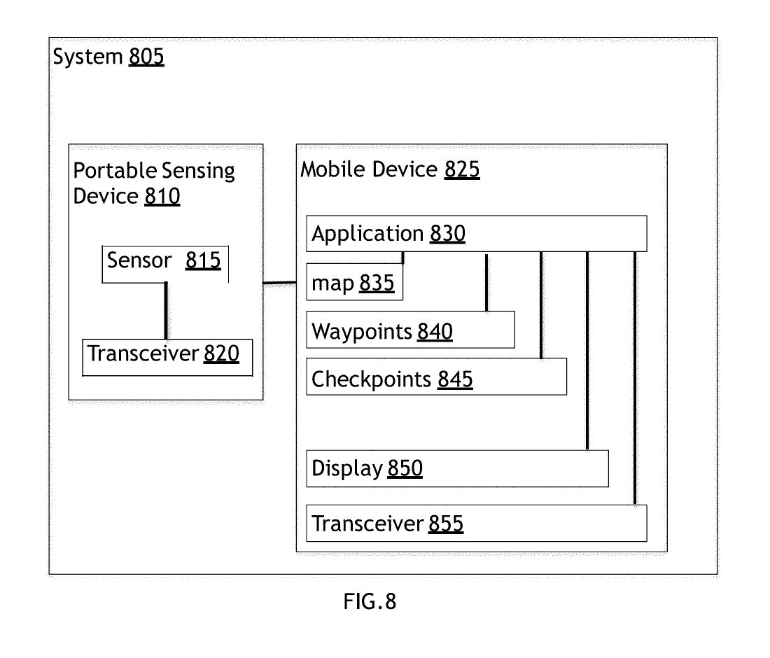

FIG. 8 illustrates a diagram of a system of navigational usage that includes at least a portable sensing device and a mobile device. The system 805 comprises a portable sensing device 810 and a mobile device 825. The portable device 810 includes a sensor 815 and a transmitter 820. The mobile device 825 includes application 830, map 835, waypoints 840, checkpoints 845, display 850 and transmitter 855. Sensor 815 can sense geo-information from surroundings of a user and pass information to the transmitter 820. The transmitter 820 of the portable sensing device 810 can pass information to the transmitter 855 of the mobile device 825. The application 830 can process the information and generate map 835, waypoints 840 and checkpoints 845. The display 850 can display map 835, waypoints 840 and checkpoints 845.

In some embodiment, the sensor 815 is configured to sense locational differences between the user's position during a trip and the starting point where a user started the trip, wherein the locational differences are three-dimensional. In some embodiment, navigation waypoints are generated by recording the geo-position of the user by a pre-determined time interval or manually generated by a user. Multi-Media information, audio, video, and image information can be generated or left by the user. In some embodiments, map 835 is generated by an algorithm stored in the portable device. In some embodiments, navigation waypoints 840 are generated by recording the geo-position of the user by a pre-determined time interval. In some embodiments, the checkpoints 845 are generated by user manually click some button on the portable sensing device 810 or by a pre-determined algorithm automatically. In some embodiment, images, texts and videos related to the waypoints 840 during the trip are stored with the respective waypoints, and the respective waypoints can be selected by user manually. In some embodiment, one or more checkpoints 845 can be placed by the user, wherein the one or more checkpoints 845 are configured to correct the map.

In some embodiment, the portable sensing device 810 includes at least an sensor 815, and a wireless transmitter 820, wherein the sensor 815 is configured to sense locational differences during a trip between two sample positions, wherein the locational differences are three-dimensional, wherein the wireless transmitter is configured to transmit the locational differences relative to between the two sample positions to other devices;

In some embodiments, the mobile device 825 is configured to receive information of the locational differences between the two sample positions, wherein the mobile device 825 is configured to have applications to process the information of the locational differences between the two sample positions and generate a map 835 containing between the two sample positions and the navigation way points 840 for the trip.

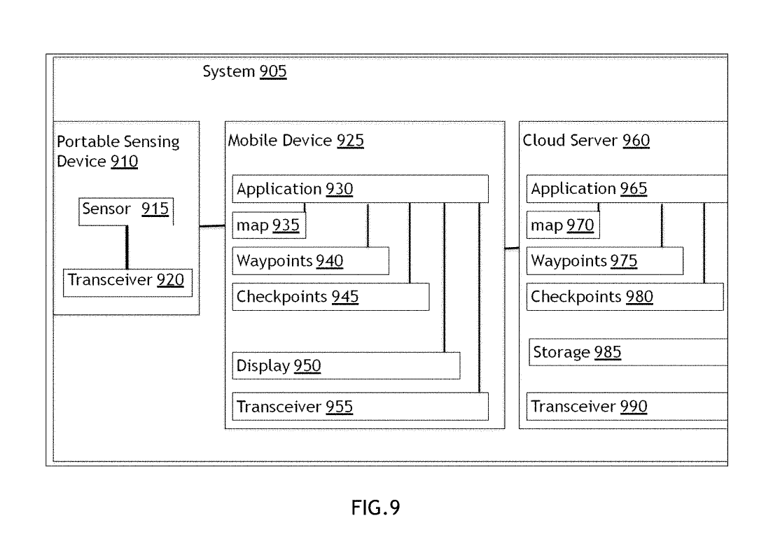

FIG. 9 illustrates a diagram of a system of navigational usage that includes at least a portable sensing device, a mobile device and a cloud server. The system 905 comprises a portable sensing device 910, a mobile device 925 and a cloud server 960. The portable device 910 includes a sensor 915 and a transmitter 920. The mobile device 925 includes application 930, map 935, waypoints 940, checkpoints 945, display 950 and transmitter 955. The cloud server 960 includes application 965, map 970, waypoints 975, checkpoints 980, display 985 and transmitter 990. Sensor 915 can sense geo-information from surroundings of a user and pass information to the transmitter 920. The transmitter 920 of the portable sensing device 910 can pass information to the transmitter 955 of the mobile device 925. The application 930 can process the information and generate map 935, waypoints 940 and checkpoints 945. The display 950 can display map 935, waypoints 940 and checkpoints 945. In some embodiment, the transmitter 955 of the mobile device 925 can pass information to the transmitter 990 of the cloud server 960. The application 965 can process the information and generate map 970, waypoints 975 and checkpoints 980. The storage 985 can store map 970, waypoints 975 and checkpoints 980.

In some embodiment, the sensor 915 is configured to sense locational differences between the user's two sample positions, wherein the locational differences are three-dimensional. In some embodiment, navigation waypoints are generated by recording the geo-position of the user by a pre-determined time interval or manually generated by a user. Multi-Media information, audio, video, and image information can be generated or left by the user. In some embodiments, map 935 is generated by an algorithm stored in the portable device. In some embodiments, navigation waypoints 940 are generated by recording the geo-position of the user by a pre-determined time interval. In some embodiments, the checkpoints 945 are generated by user manually click some button on the portable sensing device or by a pre-determined algorithm automatically. In some embodiment, images, texts and videos related to the waypoints 940 during the trip are stored with the respective waypoints, and the respective waypoints can be selected by user manually. In some embodiment, one or more checkpoints 945 can be placed by the user, wherein the one or more checkpoints 945 are configured to correct the map.

In some embodiment, the mobile phone does not process the map itself, it transmit the information to the cloud server 960. Cloud server 960 can process information and generate map 970, waypoint 975 and checkpoint 980.

In some embodiment, the portable sensing device 910, wherein the portable sensing device 910 includes at least an sensor 915, and a wireless transmitter 920, wherein the sensor 915 is configured to sense locational differences during a trip between two sample positions, wherein the locational differences are three-dimensional, wherein the wireless transmitter 920 is configured to transmit the locational differences relative to between the two sample positions to other devices;

In some embodiment, the mobile device 925 is configured to receive and store information of locational differences between the two sample positions, wherein the mobile device 925 is configured to two modes, wherein in the first mode, the mobile device 925 is configured to pre-process and upload the information of the locational differences between the two sample positions to any cloud-based server 960, wherein in the second mode, the mobile device 925 is configured to process the information and generate a map containing between the two sample positions and the navigation way points 940 for the trip. In some embodiment, one or more checkpoints can be placed by the user. In some embodiment, the one or more checkpoints can be used by the user to correct the navigation errors. In some embodiment, the multi-media information can be linked to the waypoints.

In some embodiment, a cloud-based server 960 is configured to receive the information of the locational differences between the two sample positions from the mobile device 925 via a wireless network, wherein the cloud-based server 960 is configured to process the information and generate a map 970 containing between the two sample positions and the navigation way 975 points for the trip, wherein the cloud-based server 960 is configured to share the map 970 within a pre-determined group of mobile devices.

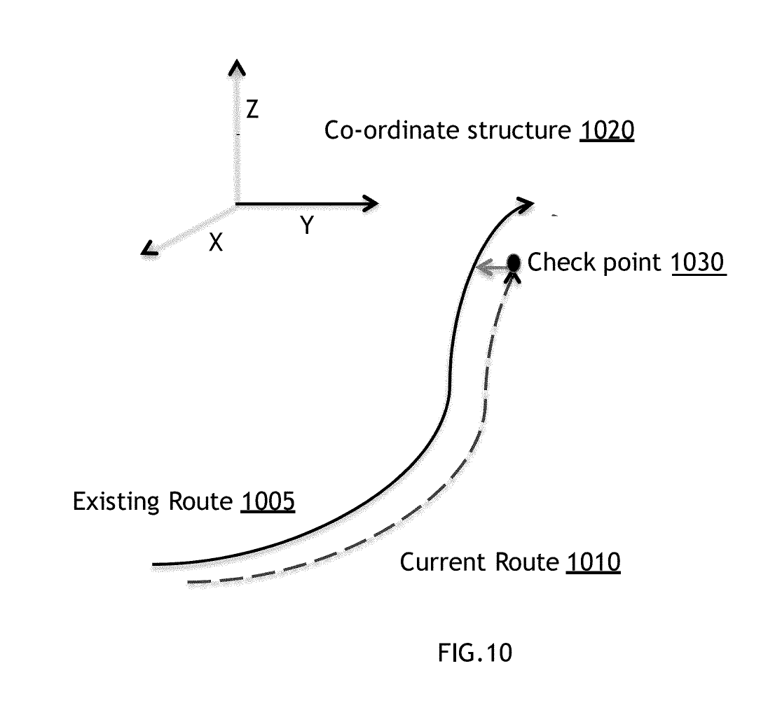

FIG. 10 illustrates an example of using check point and existing route to identify position of a user in the current route. Existing route 1005 can be a route travelled by a user in an earlier time and stored in a system of relevance. A user stopped at a checkpoint 1030 on a current route 1010 can use the route match to check whether she or he are using any existing routes and get information about existing route 1005. Coordinate structure 1020 can provide reference for directions.

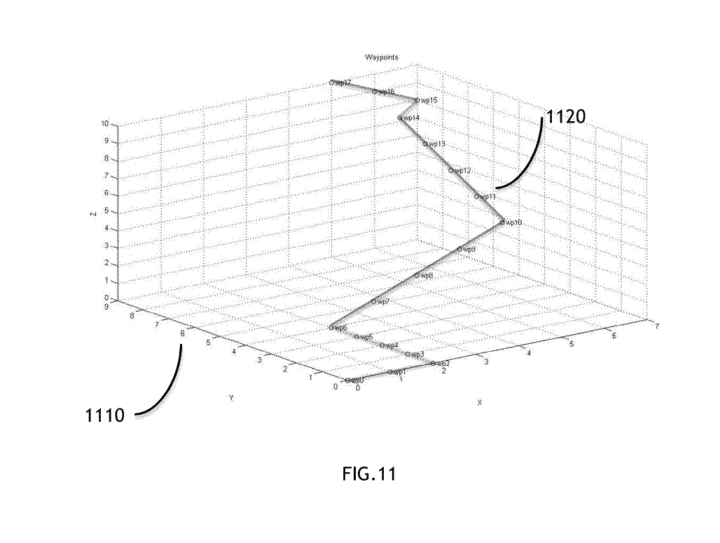

FIG. 11 illustrates a diagram of a route and waypoints in it. Map structure 1110 provides a reference of locations and directions. A route with waypoints 1120 can be stored in a system of navigation and can be uploaded into any cloud server.

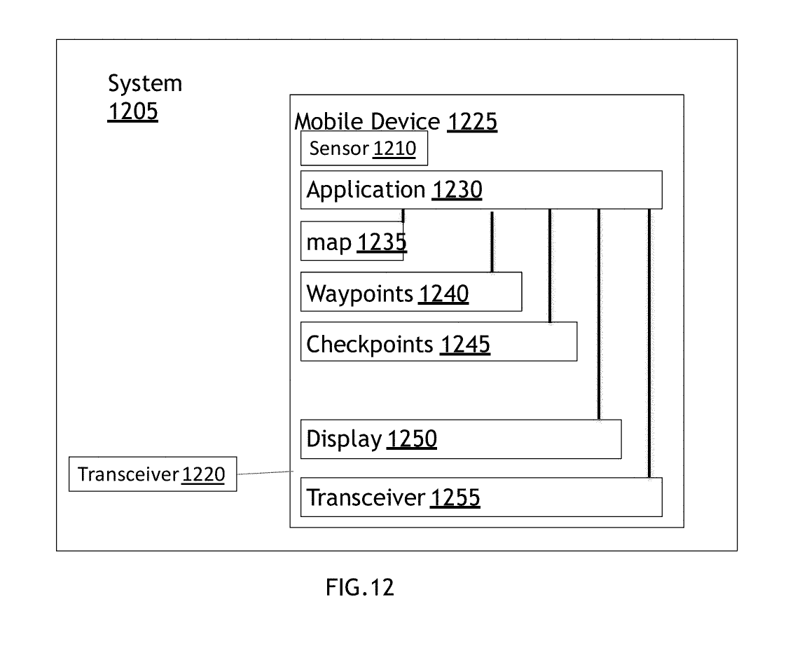

FIG. 12 illustrates a diagram of a system of navigational usage that includes at least a portable sensing device and a mobile device. The system 1205 comprises a transceiver 1220 and a mobile device 1225. The mobile device 1225 includes application 1230, map 1235, waypoints 1240, checkpoints 1245, display 1250 and transmitter 1255. Sensor 1215 can sense geo-information from surroundings of a user and pass information to the transmitter 1220. The transmitter 1220 of the portable sensing device 1210 can pass information to the transmitter 1255 of the mobile device 1225. The application 1230 can process the information and generate map 1235, waypoints 1240 and checkpoints 1245. The display 1250 can display map 1235, waypoints 1240 and checkpoints 1245.

In some embodiment, the sensor 1215 is configured to sense locational differences between the user's position during a trip and the starting point where a user started the trip, wherein the locational differences are three-dimensional. In some embodiment, navigation waypoints are generated by recording the geo-position of the user by a pre-determined time interval or manually generated by a user. Multi-Media information, audio, video, and image information can be generated or left by the user. In some embodiments, map 1235 is generated by an algorithm stored in the portable device. In some embodiments, navigation waypoints 1240 are generated by recording the geo-position of the user by a pre-determined time interval. In some embodiments, the checkpoints 1245 are generated by user manually click some button on the portable sensing device 1210 or by a pre-determined algorithm automatically. In some embodiment, images, texts and videos related to the waypoints 1240 during the trip are stored with the respective waypoints, and the respective waypoints can be selected by user manually. In some embodiment, one or more checkpoints 1245 can be placed by the user, wherein the one or more checkpoints 1245 are configured to correct the map.

In some embodiment, the system 1205 communicate with mobile device 1225 by the transceiver 1220

In some embodiments, the mobile device 1225 is configured to receive information of the locational differences between the two sample positions, wherein the mobile device 1225 is configured to have applications to process the information of the locational differences between the two sample positions and generate a map 1235 containing between the two sample positions and the navigation way points 1240 for the trip.

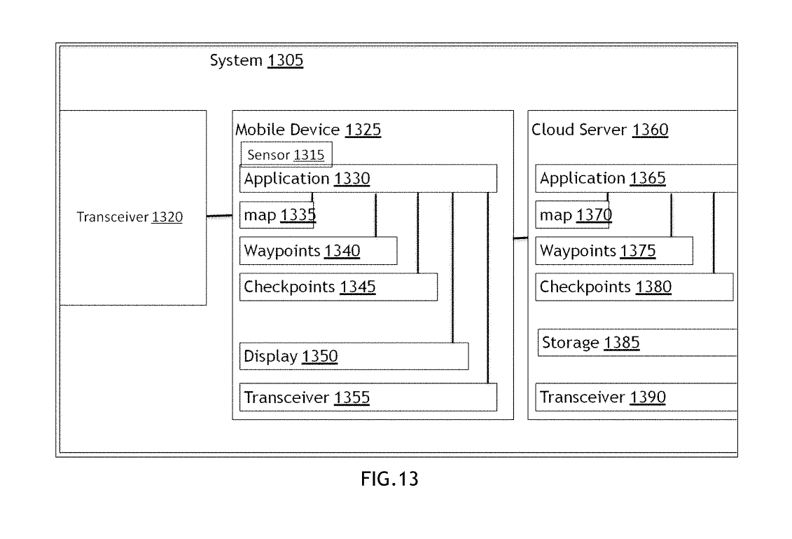

FIG. 13 illustrates a diagram of a system of navigational usage that includes at least a portable sensing device, a mobile device and a cloud server. The system 1305 comprises a transceiver 1320, a mobile device 1325 and a cloud server 1360. The portable device 1310 includes a sensor 1315 and a transmitter 1320. The mobile device 1325 includes application 1330, map 1335, waypoints 1340, checkpoints 1345, display 1350 and transmitter 1355. The cloud server 1360 includes application 1365, map 1370, waypoints 1375, checkpoints 1380, display 1385 and transmitter 13130. The sensor 1315 in the mobile device measures the movement, the computation unit in the mobile device calculates to the waypoint, generate map and user of the mobile device add notations to the map. The application 1330 can process the information and generate map 1335, waypoints 1340 and checkpoints 1345. The display 1350 can display map 1335, waypoints 1340 and checkpoints 1345. In some embodiment, the transmitter 1355 of the mobile device 1325 can pass information to the transmitter 13130 of the cloud server 1360. The application 1365 can process the information and generate map 1370, waypoints 1375 and checkpoints 1380. The storage 1385 can store map 1370, waypoints 1375 and checkpoints 1380.

In some embodiment, the sensor 1315 is configured to sense locational differences between the user's two sample positions, wherein the locational differences are three-dimensional. In some embodiment, navigation waypoints are generated by recording the geo-position of the user by a pre-determined time interval or manually generated by a user. Multi-Media information, audio, video, and image information can be generated or left by the user. In some embodiments, map 1335 is generated by an algorithm stored in the portable device. In some embodiments, navigation waypoints 1340 are generated by recording the geo-position of the user by a pre-determined time interval. In some embodiments, the checkpoints 1345 are generated by user manually click some button on the portable sensing device or by a pre-determined algorithm automatically. In some embodiment, images, texts and videos related to the waypoints 1340 during the trip are stored with the respective waypoints, and the respective waypoints can be selected by user manually. In some embodiment, one or more checkpoints 1345 can be placed by the user, wherein the one or more checkpoints 1345 are configured to correct the map.

In some embodiment, the mobile phone does not process the map itself, it transmit the information to the cloud server 1360. Cloud server 1360 can process information and generate map 1370, waypoint 1375 and checkpoint 1380.

In some embodiment, the sensor 1315, wherein the portable sensing device 1310 includes at least an sensor 1315, and a wireless transmitter 1320, wherein the sensor 1315 is configured to sense locational differences during a trip between two sample positions, wherein the locational differences are three-dimensional, wherein the wireless transmitter 1320 is configured to transmit the locational differences relative to between the two sample positions to other devices;

In some embodiment, the mobile device 1325 is configured to receive and store information of locational differences between the two sample positions, wherein the mobile device 1325 is configured to two modes, wherein in the first mode, the mobile device 1325 is configured to pre-process and upload the information of the locational differences between the two sample positions to any cloud-based server 1360, wherein in the second mode, the mobile device 1325 is configured to process the information and generate a map containing between the two sample positions and the navigation way points 1340 for the trip. In some embodiment, one or more checkpoints can be placed by the user. In some embodiment, the one or more checkpoints can be used by the user to correct the navigation errors. In some embodiment, the multi-media information can be linked to the waypoints.

In some embodiment, a cloud-based server 1360 is configured to receive the information of the locational differences between the two sample positions from the mobile device 1325 via a wireless network, wherein the cloud-based server 1360 is configured to process the information and generate a map 1370 containing between the two sample positions and the navigation way 1375 points for the trip, wherein the cloud-based server 1360 is configured to share the map 1370 within a pre-determined group of mobile devices

1. A method for generating navigation waypoints according to a trip by a user, comprising:
establishing a starting point where the user starts the trip in a map contained by a portable sensing device, wherein the portable sensing device is configured to sense locational differences between two sample positions of the user;
receiving information of the locational differences between the two sample positions of the user;
generating navigation waypoints from the information the locational differences between the two sample positions and recording detailed turn by turn instructions, upstairs or downstairs information, doors and slope information with the navigation waypoints; and
storing the navigation waypoints in a navigation file.

2. The method in claim 1, further comprising:
receiving user's instruction, downloading from internal library or a cloud server; and displaying the waypoints in a display.

3. A method in claim 1, further comprising:
starting from the starting point in the map;
following the navigation way points;
generating a moving track, comparing with downloaded map and correcting errors; and
reminding the user with turn-by-turn, door way, upstairs or downstairs, upslope or downslope instructions.

4. A method in claim 5, wherein the instructions are audio and the user is blind.

5. The method in claim 1, wherein one or more checkpoints can be placed by the user, wherein the one or more checkpoints can be used by the user to correct the navigation errors, wherein the multi-media information can be linked to the waypoints, wherein the user is informed about all the destination options that are available to the user, wherein the user can use voice to tell device the destination information, wherein the user can get the directions for the navigation by a voice reminder.

6. A portable sensing device, comprising:
an sensor, wherein the sensor is configured to sense locational differences between a user's two sample position during a trip, wherein the locational differences are three-dimensional;
a map, wherein the map is configured to record the locational differences from the sensor during the trip by the user and generate navigation waypoints, wherein and the detailed turn by turn instructions, upstairs or downstairs information, doors and slope information with the navigation waypoints are recorded with the navigation waypoints; and
a memory unit, wherein the memory unit stores the map and navigation waypoints.

7. The portable sensing device of claim 6, further comprising:
a wireless transmitter, wherein the wireless transmitter is configured to transmit the map and the navigation way points to other mobile devices.

8. The portable sensing device of claim 6, further comprising:
a display, wherein the display is configured to show between the two sample positions, the navigation way points overlay with the map, wherein the portable sensing device is configured to tell the user all the destination options that are available to the user, wherein the user can use voice to tell the portable sensing device the destination information, wherein the portable sensing device can use audio to dictate to the user the directions for the navigation.

9. The portable sensing device of claim 5, wherein images, texts and videos related to the waypoints during the trip are stored with the respective waypoints, wherein the respective waypoints can be selected by user manually, wherein one or more checkpoints can be placed by the user, wherein the one or more checkpoints are configured to correct the map, wherein the one or more checkpoints can be used by the user to correct the navigation errors, wherein the multi-media information can be linked to the waypoints.

10. A system for generating and utilizing navigation waypoints, comprising:
a portable sensing device, wherein the portable sensing device includes at least an sensor, and a wireless transmitter, wherein the sensor is configured to sense locational differences during a trip between two sample positions, wherein the locational differences are three-dimensional, wherein the wireless transmitter is configured to transmit the locational differences relative to between the two sample positions to other devices, wherein detailed turn by turn instructions, upstairs or downstairs information, doors and slope information are recorded with the locational differences; and
a mobile device, wherein the mobile device is configured to receive information of the locational differences between the two sample positions, wherein the mobile device is configured to have applications to process the information of the locational differences between the two sample positions and generate a map containing the information of the locational differences between the two sample positions and the navigation way points for the trip.

11. The system of the claim 10, wherein the mobile device has a display to visualize the map and the navigation way points.

12. The system of claim 10, wherein the mobile device has a mobile application to share the map and the navigation way points with other mobile devices.

13. The system of claim 10, wherein images, texts and videos related to the waypoints during the trip are stored with the respective waypoints, wherein one or more checkpoints can be placed by the user, wherein the one or more checkpoints are configured to correct the map.

14. A system for generating and utilizing navigation waypoints, comprising:
a portable sensing device, wherein the portable sensing device includes at least an sensor, and a wireless transmitter, wherein the sensor is configured to sense locational differences during a trip between two sample positions, wherein the locational differences are three-dimensional, wherein the wireless transmitter is configured to transmit the locational differences between the two sample positions to other devices, wherein detailed turn by turn instructions, upstairs or downstairs information, doors and slope information are recorded with the locational differences;
a mobile device, wherein the mobile device is configured to receive and store information of the locational differences between the two sample positions where a user started the trip, wherein the mobile device is configured to two modes, wherein in the first mode, the mobile device is configured to pre-process and upload the information of the locational differences between the two sample positions to any cloud-based server, wherein in the second mode, the mobile device is configured to process the information and generate a map containing the information of the locational differences between the two sample positions and the navigation way points for the trip, wherein the mobile device is configured to generate a moving track, compare with downloaded map, correct errors and remind the user with turn-by-turn, door way, upstairs or downstairs, upslope or downslope instructions, wherein the instructions can be visual or audio; and
a cloud-based server, wherein the cloud-based server is configured to receive the information of the locational differences between the two sample positions from the mobile device via a wireless network, wherein the cloud-based server is configured to process the information and generate a map containing the information of the locational differences between the two sample positions and the navigation way points for the trip, wherein the cloud-based server is configured to share the map within a pre-determined group of mobile devices.

15. The system of claim 14, wherein the wireless network is a secured wireless network.

16. The system of claim 14, wherein images, texts and videos related to the waypoints during the trip are stored with the respective waypoints.

17. The system of claim 14, wherein the portable sensing device is attached to footwear of the user.

18. The system of claim 16, wherein the cloud-based server is configured to upload the information of the waypoints and the images, the texts and the videos related the waypoints to social media accounts of the user, wherein one or more checkpoints can be placed by the user, wherein the one or more checkpoints are configured to correct the map.

19. The system of claim 18, wherein the system is configured to match a second user's movement tracking pattern to a segment of the map to identify position of the second user's position at the map.

20. The system of claim 14, wherein the one or more checkpoints can be used by the user to correct the navigation errors, wherein the multi-media information can be linked to the waypoints, wherein the portable sensing device is configured to tell the user all the destination options that are available to the user, wherein the user can use voice to tell the portable sensing device the destination information, wherein the portable sensing device can use audio to dictate to the user the directions for the navigation.
